(19) United States
(12) Patent Application Publication
(10) Pub. No.: US 2006/0157111 A1
(43) Pub. Date: Jul. 20, 2006

(54) Backflow preventer

(75) Inventor: Wolfgang Mueller, Geradstetten (DE)

Correspondence Address: Lipsitz & McAllister, LLC, 755 MAIN STREET, MONROE, CT, 06468, US

(73) Assignee: Alfred Kaercher GmbH & Co. KG, Winnenden (DE)

(21) Appl. No.: 11/342,298

(22) Filed: Jan. 27, 2006

Related U.S. Application Data
(63) Continuation of application No. PCT/EP04/08415, filed on Jul. 28, 2004.

(30) Foreign Application Priority Data
Jul. 28, 2003 (DE) 103 35 380

(51) Int. Cl. F16K 24/00

(52) U.S. Cl. 137/218

(57) ABSTRACT

The invention relates to a backflow preventer having a housing, which has an inlet opening, an outlet opening and at least one leakage opening disposed between these openings and accommodates first and second nonreturn valves disposed in series, the first nonreturn valve being held displaceably in order to open up and close a flow connection between an intermediate space of the housing and the leakage opening. To develop the backflow preventer in such a manner that an inadmissible increase in pressure in the region of the outlet opening can be avoided in a structurally simple way, according to the invention it is proposed that the housing comprises an inner housing and an outer housing, the outer housing having the at least one leakage opening and the inner housing accommodating the two nonreturn valves and being held such that it can be displaced to and fro in the direction of through-flow within the outer housing, and the inner housing having an outlet opening, via which the flow connection between the intermediate space and the leakage opening can be produced independently of the position of the inner housing, by displacement of the first nonreturn valve relative to the second nonreturn valve.

This application is a continuation of international application number PCT/EP2004/008415 filed on Jul. 28, 2004.

The present disclosure relates to the subject matter disclosed in international application number PCT/EP2004/008415 of Jul. 28, 2004 and German application number 103 35 380.1 of Jul. 28, 2003, which are incorporated herein by reference in their entirety and for all purposes.

### BACKGROUND OF THE INVENTION

The invention relates to a backflow preventer, in particular for connecting a high-pressure cleaning appliance to a drinking water supply line, having a housing, which has an inlet opening, an outlet opening and at least one leakage opening disposed between the inlet opening and the outlet opening in the direction of through-flow and which accommodates a first and a second nonreturn valve, which are disposed in series in the direction of through-flow, the first nonreturn valve being held displaceably so as to open up or close a flow connection between an intermediate space, disposed between the two nonreturn valves of the housing and the leakage opening.

Backflow preventers of this type are also known as “pipe interrupters” and are known from laid-open specification DE 24 24 978 A1. They are used for cleaning appliances, in particular high-pressure cleaning appliances or washing machines. If cleaning appliances of this type are connected to a drinking water supply line, it is necessary to ensure that contaminated cleaning liquid cannot pass back from the cleaning appliance into the drinking water supply line. For this purpose, a backflow preventer of the type described in the introduction is fitted between the drinking water supply line and the cleaning appliance. This backflow preventer includes nonreturn valves in order to prevent the contaminated cleaning liquid from running back into the drinking water supply line. In this context, it is customary to use two nonreturn valves with an identical closing direction connected in series, so as to ensure that even if one of the two nonreturn valves fails, the other nonreturn valve can readily assume the protective function on its own.

An intermediate space between the two nonreturn valves is usually in flow communication with a leakage opening, via which the intermediate space of the housing can be emptied if the differential pressure (p₁−p_{I}) between the pressure (p₁) prevailing in the region of the inlet opening and the pressure (pᵢ) prevailing in the intermediate space drops below a predetermined value. For example, it is possible to provide that the intermediate space, disposed between the two nonreturn valves, of the housing can be automatically emptied as soon as the differential pressure between the pressure (p₁) prevailing in the region of the inlet opening and the pressure (pᵢ) prevailing in the region of the intermediate space drops below a value of 14 kPa (p₁−pᵢ<14 kPa).

To allow the said intermediate space to be emptied as required, the first nonreturn valve is disposed so as to be displaceable. A flow connection between the intermediate space and the leakage opening can be opened or blocked depending on the position of the first nonreturn valve. Flow preventers of this type have proven suitable for use in practice in so far as it is possible to reliably prevent a return flow of contaminated cleaning liquid as a result of the nonreturn valves adopting their closed position. However, in this position an increase in pressure in the region of the outlet opening of the backflow preventer can lead to the latter or even the cleaning appliance connected to it being damaged. Pressure rises of this nature, for example in high-pressure cleaning appliances, can occur briefly in the form of pressure peaks when the high-pressure cleaning appliances are switched off. The pressure peaks can be caused by small quantities of water which pass from the pressure space of the high-pressure cleaning appliances into their suction space as the appliances are being switched off and cannot escape on account of the backflow preventer coming into operation.

It is an object of the present invention to develop a backflow preventer of the type described in the introduction in such a manner that an inadmissible pressure rise in the region of the outlet opening can be avoided in a structurally simple way.

### SUMMARY OF THE INVENTION

In the case of a backflow preventer of the generic type, according to the invention this object is achieved by virtue of the fact that the housing comprises an inner housing and an outer housing, the outer housing having the at least one leakage opening and the inner housing accommodating the two nonreturn valves and being held such that it can be displaced to and fro in the direction of through-flow within the outer housing, and the inner housing having a passage opening, via which the flow connection between the intermediate space and the leakage opening can be produced independently of the position of the inner housing, by displacement of the first nonreturn valve relative to the second nonreturn valve.

The invention incorporates the concept that it is possible to avoid an inadmissible pressure rise in the region of the outlet opening in a structurally simple way by virtue of the fact that the housing is of two-part configuration, with an outer housing and an inner housing held displaceably in the outer housing, the inner housing accommodating the two nonreturn valves. With this type of configuration of the backflow preventer, an inadmissible pressure rise in the region of the outlet opening of the housing leads to the inner housing together with the two nonreturn valves being displaced within the outer housing, in the opposite direction to the direction of through-flow. Therefore, an inadmissible pressure rise in the region of the outlet opening can be counteracted by displacement of the inner housing in the opposite direction to the direction of through-flow.

Despite the displaceable holding of the inner housing which accommodates the two nonreturn valves, according to the invention it is ensured that by displacing the first nonreturn valve relative to the second nonreturn valve, the intermediate space disposed between the two nonreturn valves can be emptied via the passage opening of the inner housing and the leakage opening of the outer housing. It is therefore ensured, irrespective of the position of the inner housing, that, for example in the event of a leak in the second nonreturn valve and an associated inadmissible pressure rise in the region of the intermediate space, the intermediate space can be reliably emptied, and therefore a backflow into the region of the inlet opening and of the drinking water supply line which may be connected to it is reliably prevented.

Therefore, in addition to its function of preventing a backflow from a connected cleaning appliance into the drinking water supply line, the backflow preventer according to the invention also has a pressure relief function, without expensive separate components having to be used for this purpose. The structural volume of the backflow preventer can be kept relatively small, and the backflow preventer can be produced at low cost.

In the configuration according to the invention, a displacement movement on the part of the inner housing is controlled by the difference in the pressures prevailing in the region of the inlet opening and of the outlet opening. There is no need for additional spring elements for positioning the inner housing within the outer housing. If the backflow preventer according to the invention is used when a high-pressure cleaning appliance is connected to a drinking water supply line, a pressure rise which forms within the outlet opening when the high-pressure cleaning appliance is switched off can be prevented by the inner housing carrying out a pressure compensation movement counter to the direction of flow through the backflow preventer.

Preferably, the outer housing and the inner housing between them define a sealed leakage space, via which the passage opening is in flow communication with the leakage opening of the outlet housing. The leakage space makes it possible to ensure, in a manner which is particularly simple in structural terms, that the intermediate space between the two nonreturn valves can be emptied in the event of an inadmissible pressure rise in the intermediate space, irrespective of the position of the inner housing relative to the outer housing. For this purpose, the leakage space provides a flow connection from the passage opening of the inner housing to the leakage opening of the outer housing.

It is particularly expedient if the leakage space annularly surrounds the inner housing. For example, it is possible to provide that the leakage space is defined by a circumferential groove in the inner housing, in which case the passage opening opens out into the circumferential groove and the latter is sealed by a region of the outer housing which comprises the leakage opening.

In a configuration which is particularly simple in structural terms, the leakage space is sealed off by means of sealing rings. For example, it is possible to provide that the inner housing is surrounded by two sealing rings, which are disposed at a distance from one another in the direction of through-flow and delimit the leakage space in the direction of through-flow.

It is expedient if the outer housing has an accommodating region, on the inner wall of which the inner housing is held in such a manner that it can be displaced in a sliding manner by means of sealing rings. The inner housing may, for example, be configured in the manner of a piston and be disposed displaceably in a cylindrical outer housing and may accommodate the two nonreturn valves.

In a particularly preferred embodiment of the backflow preventer according to the invention, the inner housing has a sleeve which surrounds the two nonreturn valves and is surrounded in the circumferential direction by two sealing rings disposed at an axial distance from one another. The sleeve may be configured as a hollow cylinder and may be integrally connected to a base and a cover, which each comprise a through-bore, through which a liquid, preferably water, can flow when the backflow preventer is in use.

It is advantageous if the first nonreturn valve comprises a closure spring and is supported on the second nonreturn valve by means of the closure spring. The closure spring in this case performs a dual function, since firstly it can be used to apply a restoring force, in the direction of an associated valve seat of the first nonreturn valve, to a closure body of the first nonreturn valve. Accordingly, to open the first nonreturn valve, it is necessary to apply an opening force, which counteracts the spring force of the closure spring, to the closure body. On the other hand, the closure spring which is supported against the second nonreturn valve, via the closure body and the associated valve seat of the first nonreturn valve, also acts on the valve housing of the latter. Therefore, by means of the closure spring, a restoring force which is directed in the opposite direction to the direction of through-flow can be exerted on the first nonreturn valve, in such a manner that the first nonreturn valve is pre-loaded by the closure spring and can be displaced, counter to the action of the closure spring, from a position in which it opens up the flow connection between the intermediate space of the housing and the leakage opening into a position in which the abovementioned flow connection is blocked off. This makes it possible to dispense with an additional restoring spring for the first nonreturn valve.

In an advantageous embodiment, the first nonreturn valve has a valve housing with a valve seat, the valve housing being held displaceably in a valve holder disposed within the inner housing. Fitting of the backflow preventer according to the invention can be simplified by means of the valve holder. In this case, the valve holder and the valve housing of the first nonreturn valve can have a relatively high dimensional accuracy in order to ensure that the valve housing of the first nonreturn valve is displaceable relative to the second nonreturn valve. The valve holder can be inserted into the inner housing. It is in this case advantageous if at least one sealing element is disposed between the valve holder and the inner housing.

In a particularly preferred configuration, the valve holder forms a guide for the valve housing of the first nonreturn valve. For example, it is possible to provide that the valve holder has a through-bore, in which the valve housing of the first nonreturn valve is held displaceably. It is preferable for the through-bore to be of stepped configuration, with a step disposed between a first bore portion and a second bore portion, which step forms a stop face for the valve housing of the first nonreturn valve and therefore predetermines an unambiguous end position for the displaceable valve housing of the first nonreturn valve.

The valve holder is preferably releasably connectable to the second nonreturn valve, for example to its valve housing. This allows assembly of the backflow preventer according to the invention to be additionally simplified.

To increase the mechanical load-bearing capacity of the backflow preventer, it is advantageous if the first nonreturn valve has a closure body which is guided in a guide held on the second nonreturn valve. By way of example, it is possible to provide that the closure body is guided by means of a guide pin in a guide sleeve which is preferably held on the valve body of the second nonreturn valve. It is in this context particularly advantageous if the guide sleeve is integrally connected to the valve body of the second nonreturn valve.

It is expedient if the valve holder comprises at least one flow channel, via which the intermediate space disposed between the nonreturn valves is in flow communication with the passage opening of the inner housing, it being possible for the flow channel to be covered by the valve housing of the first nonreturn valve. The flow channel may, for example, be configured in the form of a radial bore, via which the intermediate space disposed between the two nonreturn valves is in flow communication with the passage opening of the inner housing. If the flow connection is to be closed off, all that is required is for the valve body of the first nonreturn valve to be displaced into a position in which it covers the flow channel.

In a particularly preferred embodiment of the backflow preventer according to the invention, it is provided that the valve housing of the first nonreturn valve, to shut off the flow connection between the intermediate space and the leakage opening, can be placed in a sealing manner against a sealing surface of the second nonreturn valve. It is in this context expedient if a sealing ring is disposed between the valve housing of the first nonreturn valve and the associated sealing surface of the second nonreturn valve. The sealing ring may, for example, be inserted into an annular groove surrounding the valve housing of the first nonreturn valve.

The following description of a preferred embodiment of the invention serves to provide a more detailed explanation in conjunction with the drawings.

### BRIEF DESCRIPTION OF THE DRAWINGS

FIG. 1: shows a longitudinal section view of a backflow preventer according to the invention, with an outer housing and an inner housing, the inner housing adopting a first limit position, and

FIG. 2: shows a longitudinal section view corresponding to FIG. 1, with the inner housing adopting a second limit position.

### DETAILED DESCRIPTION OF THE INVENTION

The drawing illustrates a backflow preventer, which is denoted overall by reference numeral 10 and includes a two-part housing 12 with a hollow-cylindrical outer housing 14 and an inner housing 16 held displaceably within the outer housing 14.

The outer housing 14 has a housing sleeve 18, which is connected to a housing cover 19 and a housing base 20. An inlet opening 22 is formed in the housing cover 19, and the housing base 20 has an outlet opening 23. At least one and preferably a plurality of leakage openings 27, distributed over the periphery of the housing sleeve 20, have been introduced into the outer housing 14 approximately midway, in the direction of through-flow 25, between the inlet opening 22 and the outlet opening 23.

The outer housing 14 surrounds an accommodating region 29 in which the inner housing 16 is held such that it can be displaced to and fro in the direction of through-flow 25.

The inner housing 16 is likewise of hollow-cylindrical configuration and comprises a sleeve 33, which is disposed at a spacing from an inner wall 31 of the housing sleeve 18 and is connected at its ends to an inner housing cover 34 and an inner housing base 35, which each have a through-bore 36 and 37, respectively, disposed coaxially with respect to the inlet opening 22 and the outlet opening 23.

Based on the direction of through-flow 25, the sleeve 33 is surrounded, both at the level of the inner housing cover 34 and at the level of the inner housing base 35, by a radially protruding collar 38 and 39, respectively, which projects radially beyond an outer wall 40 of the sleeve 33 and includes an annular groove 41, into which is inserted a sealing ring 42 and 43 which is in sealing contact against the inner wall 31 of the housing sleeve 18 of the outer housing 14. The two sealing rings 42, 43 ensure double sealing between the region of the inlet opening 22 and the region of the outlet opening 23.

The inner wall 31 of the outer housing 14 and the outer wall 40 of the inner housing 16 between them define a leakage space 45 which extends between the collar 38 and the collar 39 in the direction of through-flow 25 and is sealed off by means of the sealing rings 42 and 43.

The inner housing 16 accommodates a first nonreturn valve 47 and a second nonreturn valve 49, which adjoins the first nonreturn valve 47 in the direction of through-flow 25; these nonreturn valves each have a closing direction which is opposite to the direction of through-flow 25, and in between them they define an intermediate space 51 of the housing 12.

The first nonreturn valve 47 has an approximately cup-shaped valve housing 53 with a valve housing base 54, which is integrally adjoined, in the direction of through-flow 25, by a valve housing sleeve 55 and which carries a guide collar 56 on its side facing away from the valve housing sleeve 55.

In the region of the valve housing base 54, the first nonreturn valve 47 has a conical sealing surface 57, onto which a closure body of the first nonreturn valve 47, in the form of a valve piston 59, can be placed in a sealing manner; on its side remote from the sealing surface 57, the valve piston 59 carries a guide pin 61 surrounded by a closure spring 60.

The valve housing 53 of the first nonreturn valve 47 is held displaceably in a continuous axial bore 63, which is of stepped configuration, of a valve holder 65. The valve holder 65 rests face-to-face against a subregion of the inner side of the sleeve 63 and against the inner housing cover 34, a sealing ring 66 being disposed between the valve holder 65 and the sleeve 63.

The axial bore 63 has a first bore portion 68, which is aligned coaxially with respect to the through-bore 36 of the inner housing cover 34 and merges via a radial step 69 into a second bore portion 70, which is integrally adjoined, in the direction of through-flow 25, by a connecting sleeve 71 with an internal screw thread 72. In the transition region between the second bore portion 70 and the connecting sleeve 71, at least one and preferably a plurality of flow channels 73, which are suitably disposed equidistantly with respect to one another in the circumferential direction and open out into aligned passage openings 75 that pass through the sleeve 33 of the inner housing 16, are formed in the valve holder 65.

The second bore portion 70 of the axial bore 63 accommodates the valve housing 53 of the first nonreturn valve with the exception of its guide collar 56, which enters into the first bore portion 68, which forms a guide for the valve housing 53.

The valve holder 65 is screwed by means of the connecting sleeve 71 to a valve housing 77 of the second nonreturn valve 49, which surrounds a central flow channel 78 and comprises a conical valve seat 80 onto which a closure body in the form of a conical valve piston 82 can be placed in a sealing manner; this valve piston 82 is pre-loaded resiliently in the direction of the valve seat 80 by means of a closure spring 83. On its side facing away from the valve seat 80, the valve piston 82 is connected to a guide pin 84, the free end of which is guided in a guide sleeve 85 which is held nondisplaceably in the central flow channel 78 by means of a plurality of radially directed carrier arms 86, the carrier arms 86 forming an abutment for the closure spring 83.

On its end side 88 facing the first nonreturn valve 47, the valve housing 77 of the second nonreturn valve 49 carries a sealing surface 90, which tapers conically in the direction of through-flow 25 and against which a free end region 92 of the valve housing sleeve 55 of the first nonreturn valve 47 can be placed in a sealing manner by way of an O-ring 93.

Four webs 95, which are integrally connected to a guide sleeve 96 aligned coaxially with respect to the sealing surface 57 of the first nonreturn valve 47, are formed on the end side 88 of the valve housing 77, equidistantly with respect to one another in the circumferential direction. The guide sleeve 96 accommodates the free end region of the guide pin 61 of the first nonreturn valve 47, and the closure spring 60 of the first nonreturn valve 47 is clamped between the valve piston 59 and the webs 95, so that the first nonreturn valve 47 is supported by means of the closure spring 60 on the valve housing 77 of the second nonreturn valve 49.

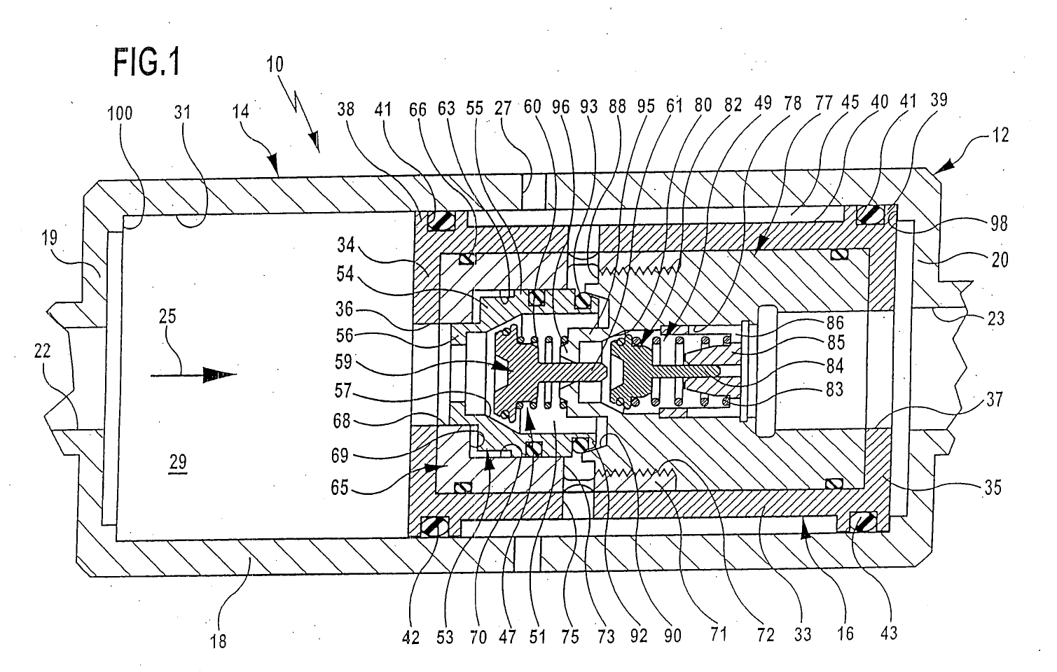

The housing 12 of the backflow preventer 10 can be connected, for example, to the suction port of a high-pressure cleaning appliance. In this case, the outer housing 14 may be integrally joined to a suction connection piece of the high-pressure cleaning appliance. In the region of the inlet opening 22, the outer housing 14 can be connected to a drinking water supply line, for example via a screw connection (not shown in the drawing). In the connected state, the water pressure which is present in the drinking water supply line can act in the region of the inlet opening 22. The result of this is that the entire inner housing 16 together with the two nonreturn valves 47 and 49 is displaced forward in the direction of through-flow 25 until the inner housing 16, in the region of the front collar 39, as seen in the direction of through-flow 25, rests against a corresponding inner shoulder 98 of the outer housing 14. The action of the water pressure leads to the first nonreturn valve 47 being displaced forward in the direction of through-flow 25, counter to the elastic restoring force of the closure spring 60, to such an extent that the free end region 92 of the valve housing 53 rests in a sealing manner against the sealing surface 90 of the valve housing 77 of the second nonreturn valve 49 and consequently the flow connection between the intermediate space 51 and the flow channel 73 and, via the latter, through the passage opening 75 to the leakage space 45 and to the leakage openings 27, is blocked. This is illustrated in FIG. 1.

When operation of the high-pressure cleaning appliance is commenced, a reduced pressure is established in the region of the outlet opening 23, and both the first nonreturn valve 47 and the second nonreturn valve 49 open in the usual way. Consequently, the water can flow through the backflow preventer 10.

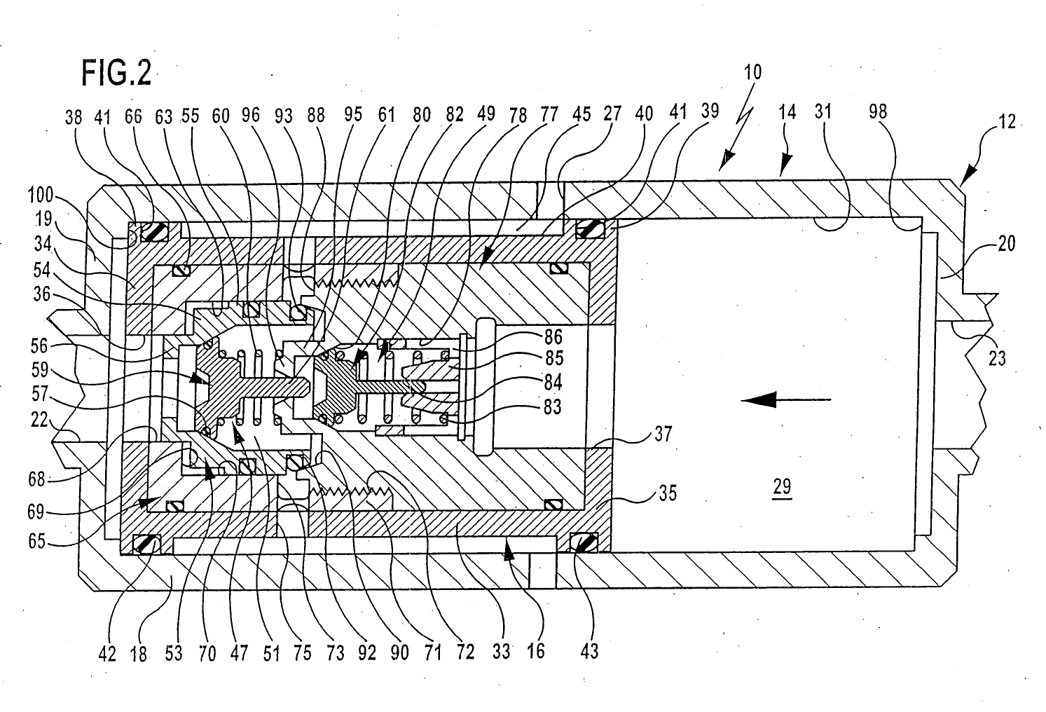

When the high-pressure cleaning appliance is switched off, the two nonreturn valves 47 and 49, on account of the closure forces of the closure springs 60 and 83, automatically adopt their closed position. When the high-pressure cleaning appliance is being switched off, an increased pressure may form in the region of the outlet opening 23, with the result that the entire inner housing 16 is displaced backward, maintaining the relative position of the nonreturn valves 47 and 49, in the direction opposite to the direction of through-flow 25, until the rear collar 38 of the inner housing 16 comes to a stop against a corresponding inner shoulder 100 of the outer housing 14. The inner housing 16 can therefore execute a yielding movement in the opposite direction to the direction of through-flow 25, with the result that a pressure increase which forms in the region of the outlet opening 23 is relieved. This is illustrated in FIG. 2.

Irrespective of the position of the inner housing 16 relative to the outer housing 14, the valve housing 53 of the first nonreturn valve 47 can lift off the sealing surface 90 of the valve housing 77 of the second nonreturn valve 49, in the opposite direction to the direction of through-flow 25, if the differential pressure (p₁−p_{I}) between the pressure (p₁) prevailing in the region of the inlet opening 22 and the pressure (p_{I}) prevailing in the region of the intermediate space 51 drops below a predetermined value, for example around 14 kPa. A pressure of this nature may form in the intermediate space 51 for example if the second nonreturn valve 49 starts to leak, so that an excess pressure which may be present in the region of the outlet opening 23 also acts as far as into the intermediate space 51. This would cause the first nonreturn valve 47 to open up the flow connection between the intermediate space 51 and the leakage openings 27, so that the intermediate space 51 can be emptied via the flow channel 73, the passage opening 75, the leakage space 45 and the leakage openings 27.

The displaceable mounting of the inner housing 16 together with the two nonreturn valves 47 and 49 in the accommodating region 29 of the outer housing 14 ensures that, for example when a high-pressure cleaning appliance connected to the backflow preventer 10 is being switched off, pressure peaks which form can be reliably absorbed, while at the same time ensuring that liquid is reliably prevented from being sucked or forced back into the drinking water supply mains even in the event of the second nonreturn valve 49 failing.

1. Backflow preventer, in particular for connecting a high-pressure cleaning appliance to a drinking water supply line, having a housing, which has an inlet opening, an outlet opening and at least one leakage opening disposed between the inlet opening and the outlet opening in the direction of through-flow and which accommodates a first and a second nonreturn valve, which are disposed in series in the direction of through-flow, the first nonreturn valve being held displaceably so as to open up or close a flow connection between an intermediate space, disposed between the two nonreturn valves of the housing and the leakage opening, wherein the housing comprises an inner housing and an outer housing, the outer housing having the at least one leakage opening and the inner housing accommodating the two nonreturn valves and being held such that it can be displaced to and fro in the direction of through-flow within the outer housing, and the inner housing having a passage opening, via which the flow connection between the intermediate space and the leakage opening can be produced independently of the position of the inner housing, by displacement of the first nonreturn valve relative to the second nonreturn valve.

2. Backflow preventer according to claim 1, wherein the outer housing and the inner housing between them define a sealed leakage space, via which the passage opening is in flow communication with the leakage opening.

3. Backflow preventer according to claim 2, wherein the leakage space annularly surrounds the inner housing.

4. Backflow preventer according to claim 2, wherein the leakage space is sealed by means of sealing rings.

5. Backflow preventer according to claim 1, wherein the outer housing has an accommodating region, on the inner wall of which the inner housing is held in such a manner that it can be displaced in a sliding manner by means of sealing rings.

6. Backflow preventer according to claim 1, wherein the inner housing has a sleeve which surrounds the two nonreturn valves and is surrounded in the circumferential direction by two sealing rings disposed at an axial distance from one another.

7. Backflow preventer according to claim 1, wherein the first nonreturn valve comprises a closure spring and is supported on the second nonreturn valve by means of the closure spring.

8. Backflow preventer according to claim 1, wherein the first nonreturn valve has a valve housing with a valve seat, the valve housing being held displaceably in a valve holder disposed within the inner housing.

9. Backflow preventer according to claim 8, wherein the valve holder forms a guide for the valve housing of the first nonreturn valve.

10. Backflow preventer according to claim 8, wherein the valve holder is releasably connectable to the second nonreturn valve.

11. Backflow preventer according to claim 8, wherein the first nonreturn valve has a closure body which is guided in a guide held on the second nonreturn valve.

12. Backflow preventer according to claim 8, wherein the valve holder comprises at least one flow channel, via which the intermediate space is in flow communication with the passage opening of the inner housing, it being possible for the flow channel to be covered by the valve housing of the first nonreturn valve.

13. Backflow preventer according to claim 1, wherein the valve housing of the first nonreturn valve, to shut off the flow connection between the intermediate space and the leakage opening, can be placed in a sealing manner against a sealing surface of the second nonreturn valve.
